(19) United States
(12) Patent Application Publication
(10) Pub. No.: US 2026/0154410 A1
(43) Pub. Date: Jun. 4, 2026

(54) SYSTEMS AND METHODS FOR DETECTING MALICIOUS CODE IN A FILE

(71) Applicant: AO Kaspersky Lab, Moscow (RU)

(72) Inventor: Boris B. LARIN, Moscow (RU)

(21) Appl. No.: 19/399,768

(22) Filed: Nov. 25, 2025

(30) Foreign Application Priority Data
Dec. 2, 2024 (RU) 2024136065

(51) Int. Cl. G06F 21/56; G06F 21/57

(52) U.S. Cl. CPC G06F 21/566; G06F 21/57; G06F 2221/033

(57) ABSTRACT

Discloses are systems and method for detecting malicious code in a file. The system receives at least one file. The system analyzes the at least one file, during which offsets from a beginning of the at least one file are detected for data that is similar to code that assembles strings in memory from data included in machine instructions. The system performs emulation of the machine instructions included in the code according to the detected offsets, further comprising: checking an effect of each respective machine instruction of the machine instructions on a control flow, and extracting strings from virtual memory if the respective machine instruction affects the control flow. The system analyzes extracted strings, during which malicious code is detected using malicious code detection rules.

### CROSS-REFERENCE TO RELATED APPLICATIONS

This application claims the benefit of Russian Patent Application No. 2024136065, filed Dec. 2, 2024, which is herein incorporated by reference.

### FIELD OF TECHNOLOGY

The present disclosure relates to the field of computer security, and, more specifically, to systems and methods for detecting malicious code in a file.

### BACKGROUND

Malicious software contains strings that are assembled by machine instructions in a computer program's memory from data contained directly in the machine instruction. Such strings are usually assembled by malicious code and are most often found in shellcode, since shellcode can be executed from any location in a computer program's memory. Attackers use such strings to complicate their detection, making signature analysis unable to recognize them. In addition, such strings may be present not only in malicious software but also in the memory of legitimate software.

For example, attackers can use an exploit to inject and execute shellcode in the Google Chrome browser. This is a problem and makes it harder to detect such strings. At the same time, it is possible that similar strings are present in legitimate software and are not constructed by malicious code; however, the very fact of their presence poses a potential information security threat, and there is a need to extract and analyze them to determine whether the code is malicious. Objects in which such strings may be present include, for example, files, email attachments, computer programs downloaded from the Internet, and memory dumps of a computer program. Technologies using emulation or sandboxing are used to detect malicious code in files.

Existing solutions that use emulation are applied to run code and extract strings from memory by taking a memory dump of the emulated process. However, only those strings that happen to be in memory at the moment the memory dump is taken will be extracted. In this case, it is impossible to determine which strings were assembled by machine instructions and which were not, which creates the technical problem of extracting strings assembled in memory and detecting malicious code based on the extracted strings.

Analysis of the prior art has shown that there is a need to improve existing technologies for extracting strings and detecting malicious code based on them.

### SUMMARY

The present disclosure describes a system that eliminates at least some of the shortcomings of known approaches related to detecting malicious code in files. The technical result is to increase the speed and accuracy of detecting malicious code in a file by extracting strings assembled in memory from data contained in machine instructions.

In an exemplary aspect, the techniques described herein relate to a method for detecting malicious code in a file, including: receiving at least one file; analyzing the at least one file, during which offsets from a beginning of the at least one file are detected for data that is similar to code that assembles strings in memory from data included in machine instructions; performing emulation of the machine instructions included in the code according to the detected offsets, further including: checking an effect of each respective machine instruction of the machine instructions on a control flow, and extracting strings from virtual memory if the respective machine instruction affects the control flow; and analyzing extracted strings, during which malicious code is detected using malicious code detection rules.

In some aspects, the techniques described herein relate to a method, wherein at a beginning of a machine instruction emulation process, the virtual memory is prepared and a machine instruction interpreter is initialized.

In some aspects, the techniques described herein relate to a method, further including, during the emulation of the machine instructions, checking whether a limit on a number of machine instructions has been reached or whether an invalid machine instruction has been detected.

In some aspects, the techniques described herein relate to a method, wherein further emulation of machine instructions is stopped if the limit on the number of machine instructions is reached or if the invalid machine instruction has been detected.

In some aspects, the techniques described herein relate to a method, wherein a search for and extraction of strings from the virtual memory is additionally performed if the machine instructions did not affect the control flow.

In some aspects, the techniques described herein relate to a method, wherein the extracted strings are additionally filtered before analysis.

In some aspects, the techniques described herein relate to a method, wherein an analysis of the at least one file in is performed using signatures, based on which the offsets are detected.

In some aspects, the techniques described herein relate to a method, wherein the detected offsets are additionally filtered to exclude any machine instructions related to legitimate software.

In some aspects, the techniques described herein relate to a method, wherein a combination of at least two malicious code detection rules is applied when analyzing the extracted strings, where at least one rule includes a hash of the extracted strings.

In some aspects, the techniques described herein relate to a system for detecting malicious code in a file, the system including: at least one memory; and at least one hardware processor coupled with the at least one memory and configured, individually or in combination, to execute: a scanner configured to: receive and analyze at least one file, during which offsets from a beginning of the at least one file are detected for data that is similar to code that assembles strings in memory from data included in machine instructions; and transfer the at least one file with the detected offsets to an emulator for emulation; the emulator configured to: emulate the machine instructions included in the code according to the detected offsets, further including checking an effect of each respective machine instruction of the machine instructions on a control flow, and extracting strings from virtual memory if the respective machine instruction affects the control flow; and an analyzer configured to: analyze the extracted strings using malicious code detection rules; and detect malicious code based on an analysis performed.

In some aspects, the techniques described herein relate to a non-transitory computer readable medium storing thereon computer executable instructions for detecting malicious code in a file, including instructions for: receiving at least one file; analyzing the at least one file, during which offsets from a beginning of the at least one file are detected for data that is similar to code that assembles strings in memory from data included in machine instructions; performing emulation of the machine instructions included in the code according to the detected offsets, further including: checking an effect of each respective machine instruction of the machine instructions on a control flow, and extracting strings from virtual memory if the respective machine instruction affects the control flow; and analyzing extracted strings, during which malicious code is detected using malicious code detection rules.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 shows an example of a system for detecting malicious code in a file.

FIG. 2 shows an example of established virtual memory regions in the emulator's virtual memory management block.

FIG. 3 shows an example algorithm for emulating machine instructions in the emulator.

FIG. 4 shows an example method for detecting malicious code in a file.

FIG. 5 shows an example computer system on which the variant aspects of system and method disclosed herein may be implemented.

### DETAILED DESCRIPTION

Exemplary aspects are described herein in the context of a system, method, and computer program product for detecting malicious code in a file. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The objects and features of the present disclosure, and methods for achieving them, may become apparent by reference to exemplary aspects. However, the present disclosure is not limited to the exemplary aspects disclosed below and may be implemented in various forms. The disclosure provided is nothing more than specific details necessary to enable a person skilled in the art to fully understand the disclosure, and the present disclosure is defined by the appended claims. Below are definitions of a number of terms used in describing aspects of the disclosure.

Emulation—in the context of information security, is a technology that allows code to be executed in a virtual environment, enabling its maliciousness to be determined and preventing suspicious objects (files) from freely spreading within the real system.

Suspicious file—a file whose execution can, with some probability, lead to unauthorized deletion, blocking, modification, copying of computer information, or neutralization of computer information protection means, where the probability can be assessed based on data about the file itself (file source, developer, user popularity) or based on data about the state of the operating system or computer program during execution of the file.

Control flow—a section of computer programming concerned with the sequential execution of computational tasks. Control flow relates to the order in which sets of instructions are executed. The term denotes how data are directed or guided through a program.

Malicious file—a file whose execution can lead to unauthorized deletion, blocking, modification, copying of computer information, or neutralization of computer information protection means.

Malicious code—code specifically designed to perform malicious actions and/or exploit vulnerabilities in a computer system and its subsystems, in particular software. Attackers develop malicious code to make unauthorized changes to a computer system, damage it, or gain long-term access to it. The result of the action of malicious code may be loading a backdoor, disabling or modifying the protection system, stealing information, and other damage to files and users' and/or organizations' computers.

Offset—an operator that obtains the address offset relative to the beginning of a segment (i.e., the number of bytes from the start of the segment to the address identifier).

Machine instruction—a single processor operation defined by the instruction set. In a broad sense, a machine instruction can be any representation of an element of an executable program, such as bytecode. In traditional architectures, a machine instruction includes an operation code that defines execution of an operation, such as “add the contents of memory to a register.”

Virtual memory—a technology used by a computer operating system (OS) enabling the OS to allocate memory to processes. A virtual address space is the set of virtual memory addresses a process can use. The address space for each process is private.

Malicious code that assembles strings in memory from data contained in machine instructions uses various ways of assembling strings. Examples of string assembly by malicious code are provided below. The example string assembled by malicious code is “KERNEL.”

TABLE 1

| Instruction (bytes) | Disassembled instruction |
|---|---|
| C6 44 24 40 4B | mov [esp+40h], 4Bh ; ‘K’ |
| C6 44 24 41 45 | mov [esp+41h], 45h ; ‘E’ |
| C6 44 24 42 52 | mov [esp+42h], 52h ; ‘R’ |
| C6 44 24 43 4E | mov [esp+43h], 4Eh ; ‘N’ |
| C6 44 24 44 45 | mov [esp+44h], 45h ; ‘E’ |
| C6 44 24 45 4C | mov [esp+45h], 4Ch ; ‘L’ |

TABLE 2

| Instruction (bytes) | Disassembled instruction |
|---|---|
| B8 4B 00 00 00 | mov eax, 4Bh ; ‘K’ |
| 66 89 45 40 | mov [ebp+0x40], ax |
| B9 45 00 00 00 | mov ecx, 45h ; ‘E’ |
| 66 89 4D 42 | mov [ebp+0x42], cx |
| BA 52 00 00 00 | mov edx, 52h ; ‘R’ |
| 66 89 55 44 | mov [ebp+0x44], dx |
| B8 4E 00 00 00 | mov eax, 4Eh ; ‘N’ |
| 66 89 45 46 | mov [ebp+0x46], ax |
| B9 45 00 00 00 | mov ecx, 45h ; ‘E’ |
| 66 89 4D 48 | mov [ebp+0x48], cx |
| BA 4C 00 00 00 | mov edx, 4Ch ; ‘L’ |
| 66 89 55 4A | mov [ebp+0x4A], dx |

In the tables above, the set of machine instructions is extensive, and code performing the same action—assembling a string in memory—may differ. In addition to the large number of machine instructions that can be used to assemble a string in memory, these machine instructions can also be arranged in different orders and interleaved with other machine instructions, which in turn complicates the detection of such strings, as shown, for example, in Table 2.

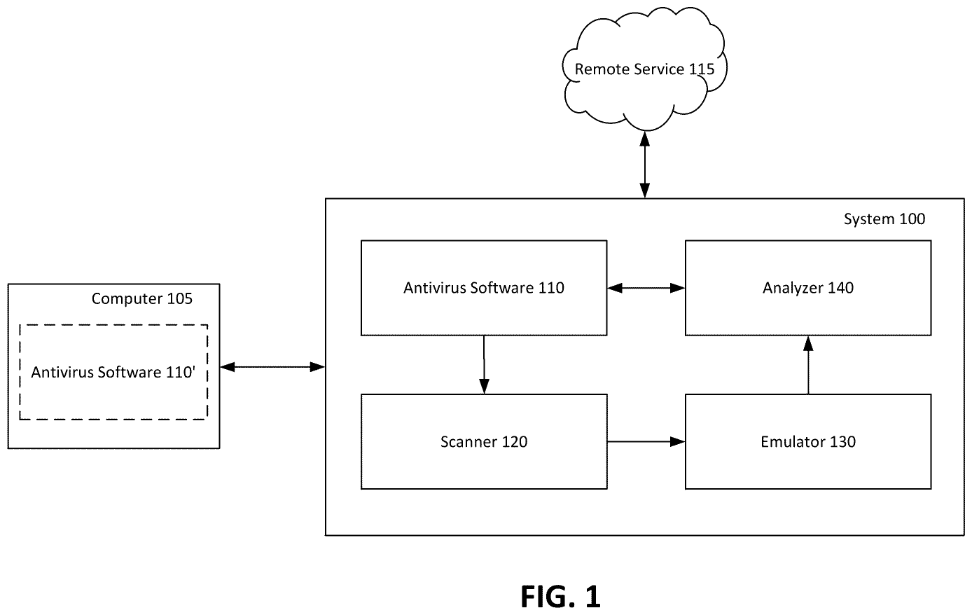

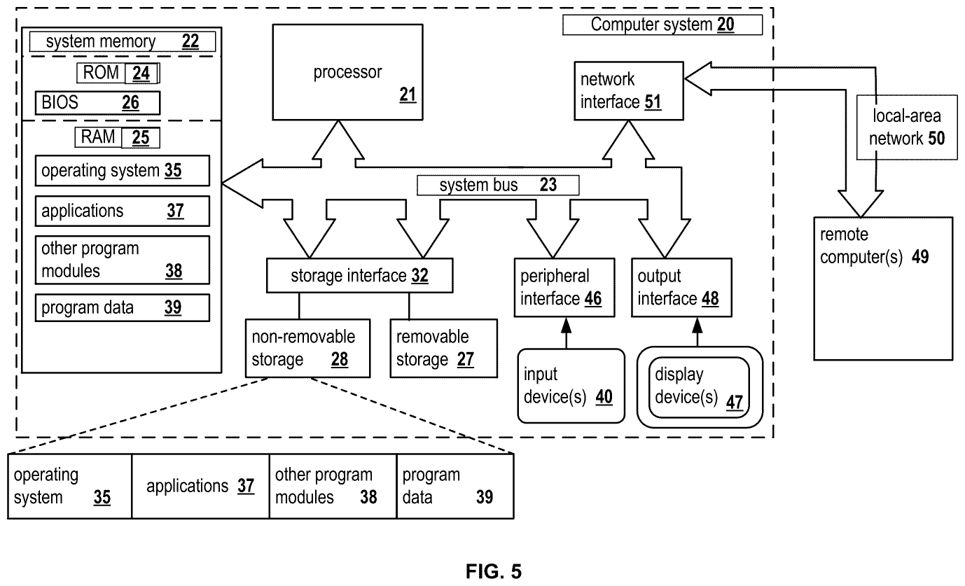

FIG. 1 shows an example of a system for detecting malicious code in a file (hereinafter, system 100). System 100 includes antivirus software 110 (hereinafter, AV software 110), a scanner 120, an emulator 130, and an analyzer 140. Elements of system 100 can be implemented on a computer system, an example of which is shown in FIG. 5 and will be discussed below. In one aspect, emulator 130 is implemented on a computer device separately from other elements of system 100 using QEMU, a solution designed for emulating hardware of various platforms. In another aspect, the scanner 120, emulator 130, and analyzer 140 are part of AV software 110.

AV software 110 is a computer application for information security and is designed to receive at least one file and transfer the file to the scanner 120. As used herein, the term ‘receive’ includes obtaining a file by any means, including (i) identifying or detecting, during monitoring or scanning, a file that meets criteria for suspicion; and (ii) accepting a file provided by another component, process, or source. In certain preferred implementations, the AV software 110 identifies a file as suspicious and then forwards it to the scanner 120 for deeper analysis. In one aspect, AV software 110 performs an antivirus scan of files. It should be noted that the antivirus scan can be performed not only on a single file, but also on a group of files, for example, if it is a computer program. The result of the antivirus scan is the classification of files as malicious, safe, or suspicious.

A scanner 120 refers to a component or software module that inspects files to identify suspicious code patterns or offsets that may indicate the presence of malicious code. For example, the scanner may be a scanning engine in an anti-virus software or an open-source tool.

An emulator 130 is a software or hardware system that mimics the behavior of a computer processor or environment, allowing code to be executed in a controlled, virtualized setting for analysis. An example of an emulator may be QEMU, which is an open-source emulator that can simulate various CPU architectures (x86, ARM, etc.) and is often used in malware analysis to safely execute and observe suspicious code.

An analyzer 140 is a software component that processes data extracted from files (such as strings or code fragments) to determine if they are associated with malicious activity, using rules, heuristics, or machine learning.

To scan files, AV software 110 uses at least signature analysis based on “whitelist” and “blacklist” databases and/or heuristic analysis. During scanning, if the scan does not show that the file is malicious or safe, the file is classified as suspicious. If it is known that the file was obtained from an untrusted source, AV software 110 also classifies such a file as suspicious. It should be noted that the present invention can be applied to any files, regardless of whether the file is malicious, safe, or suspicious by antivirus scan results. Further in this description, the term “suspicious file” will be used as an example. AV software 110 transfers each suspicious file to the scanner 120 for inspection. A suspicious file can be any format and may contain any data.

If the antivirus scan concerns a computer program that has been subjected to a cyberattack, AV software 110 checks the contents of the program's memory dump. An example of a cyberattack on a computer program is a targeted attack on the Google Chrome web browser using an exploit. AV software 110 detects suspicious activity in the program that indicates it was attacked. Before transferring the content of the program's memory dump to the scanner 120, AV software 110 stops execution of the program. Examples of AV software 110 include products of Kaspersky Lab, in particular Kaspersky Endpoint Security and Kaspersky Internet Security.

In one aspect, system 100 interacts over the Internet with a remote service 115. Remote service 115, like AV software 110, is designed to check files and, upon detecting a suspicious file, transfers it to system 100 to the scanner 120 for additional inspection. In a particular aspect, remote service 115 is a cloud infrastructure, for example Kaspersky Security Network (KSN) by Kaspersky Lab. KSN is a cloud service infrastructure that provides access to a knowledge base on the reputation of files and Internet resources (websites).

In another aspect, system 100 interacts over the Internet with a computer 105 on which AV software 110′ is installed. Computer 105 means any computing device, in particular a personal computer, laptop, smartphone, tablet, router, server, or storage system. AV software 110′ on computer 105 identifies a suspicious file and transfers it to computer system 100 to the scanner 120 for inspection.

The scanner 120 is designed to inspect each received suspicious file using heuristic analysis. During the heuristic analysis, the suspicious file is searched for offsets from the beginning of the file to data that is similar to code that assembles strings in memory from data included in machine instructions. Similar to “code that assembles strings in memory from data contained in machine instructions” means that a code region matches, above a predefined similarity threshold, a set of syntactic and semantic features characteristic of string-construction routines.

TABLE 3

| Instruction (bytes) | Disassembled instruction |
|---|---|
| B8 45 00 00 00 | mov eax, 45h ; ‘E’ |
| 89 D9 | mov ecx, ebx |
| C6 44 24 42 52 | mov [esp+42h], 52h ; ‘R’ |
| D1 E9 | shr ecx, 1 |
| C6 44 24 40 4B | mov [esp+40h], 4Bh ; ‘K’ |
| 8D 54 24 18 | lea edx, [esp+18h] |
| C6 44 24 45 4C | mov [esp+45h], 4Ch ; ‘L’ |
| 33 F6 | xor esi, esi |
| C6 44 24 43 4E | mov [esp+43h], 4Eh ; ‘N’ |
| 88 44 24 41 | mov [esp+41h], al |
| 88 44 24 44 | mov [esp+44h], al |

Table 3 demonstrates a method in which a simple search for machine instructions is performed, after which their data are concatenated and checked for ASCII characters. This method is inefficient due to selecting a small number of relevant strings and a large number of irrelevant strings. To increase the accuracy and speed of inspecting a suspicious file, the scanner 120 uses heuristic analysis.

The heuristic analysis includes at least signatures aimed at inspecting not all code but only code locations that contain certain sequences of machine instructions. This enables faster code inspection and a larger selection of relevant strings compared to the method described in Table 3. Examples of such instruction sequences include: 1) “mov [ . . . ] mov”, 2) “push [ . . . ] pop [ . . . ] mov”, 3) “push [ . . . ] push”, and others. The scanner 120 also sorts the detected offsets in ascending order. In a particular aspect, the signatures used for code inspection were formed from a large number of known shellcode and malware samples used in cyberattacks. The formed signatures are not tied to any specific malware or shellcode.

This approach allows inspection of various code and detection of offsets to data that is similar to code that assembles strings in memory from data contained in machine instructions. The scanner 120 transfers the analyzed file with information about the sorted offsets to the emulator 130 for emulation. It should be noted that emulator 130 uses the sorted offsets as markers (emulation start points) from which code is emulated with subsequent extraction of the assembled strings from virtual memory. This approach allows the desired strings to be extracted during emulation starting from a set point without needing to collect information about the beginning or end of a function's execution and the possible code emulation paths. In other words, this approach enables emulating not all the code, but only the parts necessary for detection, which in turn increases emulation speed.

In a particular aspect, before transferring offsets to the emulator 130, the scanner 120 additionally verifies and filters the detected offsets triggered by the specified signatures using heuristic rules. When filtering the sorted offsets, the first machine instructions located at the found offsets are analyzed. The analysis takes into account the type of machine instructions, the data they contain, and the size of that data. The information obtained is processed by heuristic rules aimed at checking the presence of alphanumeric characters relative to null bytes as well as checking for similarity to addresses. Filtering the sorted offsets is necessary to eliminate machine instructions related to legitimate software. The heuristic rules applied were developed based on a collection of legitimate software.

Using filtering of the sorted offsets further increases emulation performance by excluding machine instructions related to legitimate software. Examples of filtering detected offsets by the scanner 120 are given below.

TABLE 4

| Instruction (bytes) | Disassembled instruction |
|---|---|
| c7 84 24 94 fe ff | mov DWORD PTR |
| ff 6b 65 72 6e | [esp-0x16c], “NREK” |
| c7 84 24 98 fe ff | mov DWORD PTR |
| ff 65 6c 33 32 | [esp-0x168], “23LE” |

The example in Table 4 shows machine instructions that assemble strings in memory from the machine instruction itself. Both mov instructions contain the values 0x6e72656b and 0x32336c65 equal to the byte sequences 6b 65 72 6e and 65 6c 33 32. All characters in these sequences are valid ASCII characters.

TABLE 5

| Instruction (bytes) | Disassembled instruction |
|---|---|
| c7 44 24 08 01 00 00 00 | mov DWORD PTR [rsp+0x8],0x1 |
| c7 44 24 0c ff 00 00 00 | mov DWORD PTR [rsp+0xc],0xff |

The example in Table 5 shows machine instructions that do not assemble strings in memory from data. Both mov instructions contain the values 0x1 and 0xff corresponding to the byte sequences 01 00 00 00 and ff 00 00 00. None of these bytes are valid ASCII characters. In one aspect, the example in Table 5 is an invalid machine instruction. If such an instruction is passed to emulation, the emulator 130 will still be unable to emulate it. From the examples given, the example in Table 5 will be excluded by the scanner 120 during filtering and will not make it into the sorted offsets.

Emulator 130 is a code interpreter for the x86-32/x86-64/ARM/ARM64 processor architectures that may perform disassembly of machine instructions. In implementing the claimed disclosure, software-hardware simulation of computer hardware components and their various structures may be used—CPU, memory—by creating virtual copies of CPU registers and memory. Emulator 130 may be designed to emulate machine instructions contained in code according to the detected offsets, extract strings from the emulator's virtual memory, and transfer the extracted strings to analyzer 140 for analysis. As noted earlier, not all the code may be emulated, only a part of it, where the start of emulation for each code segment may be the received offsets.

During emulation, emulator 130 may determine whether the emulated code segment actually assembles strings in virtual memory from machine instructions. The emulator 130 may then extract such strings during emulation and transfer them to analyzer 140 for analysis. This approach may make it possible to achieve the stated technical result, namely increased emulation speed and extraction of necessary strings for analysis. Additionally, at the end of the emulation process, emulator 130 may check the extracted strings for strings that are constituent parts of other strings. This may occur when parts of one string are located in two regions of code. If such strings are present, they may be removed from the list of extracted strings. This check may further improve the quality of the analysis performed by analyzer 140.

The emulator 130 may operate in two stages. The first stage may consist of preparing virtual memory and initializing the machine instruction interpreter, which may be part of emulator 130. In the second stage, emulator 130 may emulate machine instructions contained in code corresponding to the detected offsets. Each stage of emulator 130 operation may be discussed in more detail below.

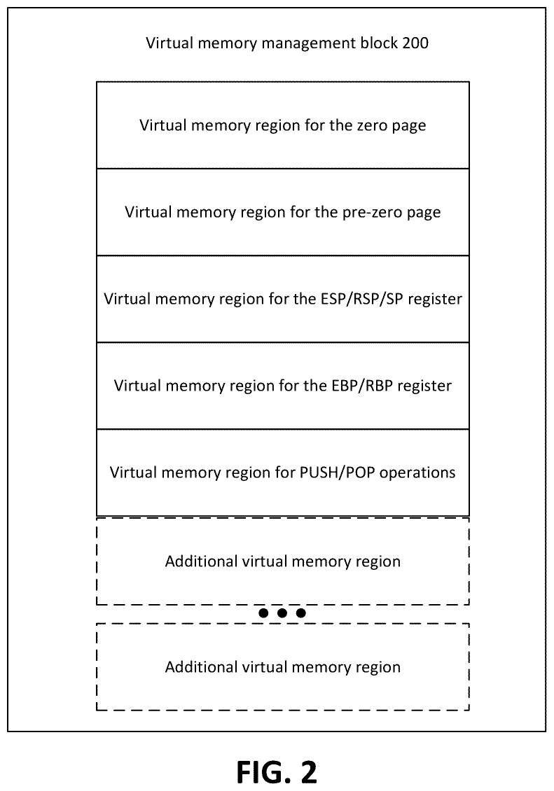

First stage—preparing virtual memory and initializing the machine instruction interpreter, which may be part of emulator 130. Emulator 130 may set up several virtual memory regions in the virtual memory management block 200, used for read/write operations. FIG. 2 shows an example of established virtual memory regions in the emulator's virtual memory management block 200. The virtual memory regions may be initialized with zeros. One of the virtual memory regions may be set for a virtual address placed in the ESP/RSP/SP register; another virtual memory region may be set for the EBP/RBP register. Another virtual memory region may be set for PUSH/POP operations. PUSH/POP operations may work with their own separate virtual memory, and the memory reserved for ESP/RSP/SP may be used only for direct memory accesses. In a particular aspect, machine instructions may access the same virtual memory reserved for ESP/RSP/SP.

Virtual addresses pointing to the established virtual memory regions may be placed in the CPU registers used to work with the stack; for example, for the x86 (IA-32) architecture the addresses may be placed in the EBP/ESP registers; for x86_64 (AMD64)—in the RBP/RSP registers; for ARM and AArch64 (ARM64)—in the SP register. Instead of an instruction pointer register, the interpreter may use the supplied offset. The values of all other registers may be set to 0. Emulator 130 may also establish a virtual memory region for the zero page at virtual address 0, with no read permissions for that virtual memory region, and may register a similar virtual memory region for the pre-zero page at the end of the virtual address space. This may be done because the values of all CPU registers, apart from those used to work with the stack and the instruction pointer, may be set to 0, and machine instructions may use this value as an address where strings will be assembled. These virtual memory regions may be treated as a single whole in cases where part of a string is written to the zero-address virtual memory region (i.e., the beginning of the virtual address space), and another part of the string is then written to a different virtual memory region at the end of the virtual address space.

In one aspect, during emulation, when an attempt is made to write to unestablished virtual memory regions, emulator 130 may establish additional virtual memory regions for such cases. If the number of write attempts is small, for example from 1 to 5, the additional virtual memory region created during emulation may be deleted by emulator 130. Emulated machine instructions may only read data from established virtual memory regions with read permissions. This approach may be aimed at ensuring that all extracted strings are assembled from data contained in machine instructions, and also to prevent strings from a data section from randomly ending up in the memory from which the assembled strings will later be extracted.

An example of the virtual memory block behavior in emulator 130 may be described below. To perform a read operation at a virtual address, that address, as well as the size of the data to be read, may need to fall within the address space of one of the established virtual memory regions, and read permissions may need to be set for the virtual memory regions. If the size of the data to be read does not lie entirely within one virtual memory region, the memory request may be split and processed as two separate requests. If code attempts to read virtual memory at an unknown address during emulation, the code may receive data filled with null bytes.

If code attempts to write data to a virtual memory region that has not been established, the attempt may be recorded and a buffer may be created for that virtual memory region; after reaching a specified number of write attempts to this virtual memory region, all recorded write attempts may be applied to write the data into that buffer.

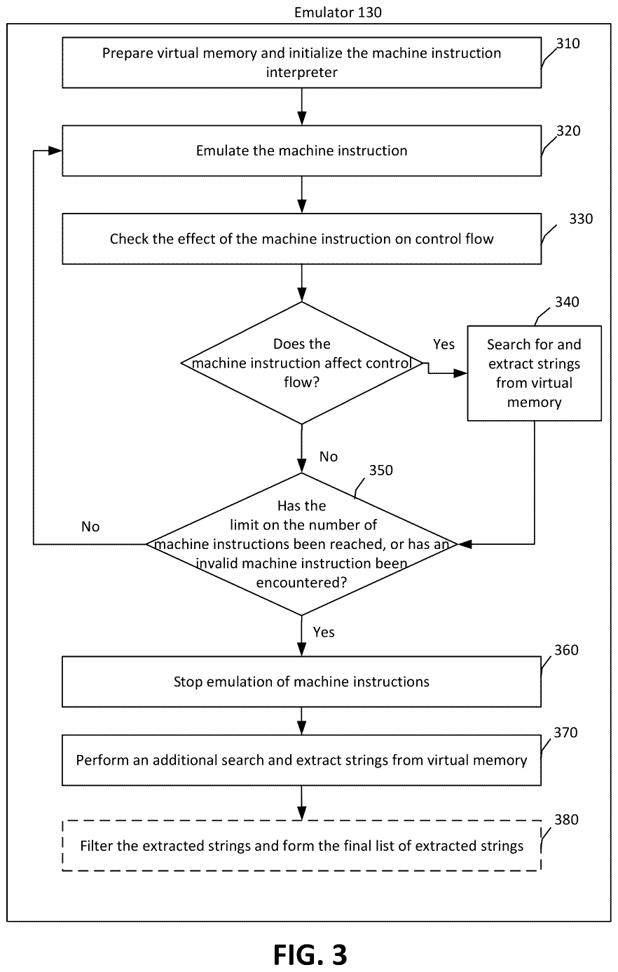

After preparing virtual memory and initializing the instruction interpreter, the second stage may begin-emulating machine instructions contained in code corresponding to the detected offsets, an example of which is shown in FIG. 3. During code emulation, the machine instructions contained in the code may be emulated sequentially. In step 310, virtual memory is prepared and the machine instruction interpreter is initialized, wherein said virtual memory and machine instruction interpreter may be part of for emulator 130. Step 310 may be the first stage of emulator 130 operation, disclosed earlier. In step 320, a machine instruction is emulated.

In step 330, emulator 130 may check whether each machine instruction affects the control flow. Examples of machine instructions that affect the control flow may include those that contain at least the operators call, jump, and/or return. If the machine instruction affects the control flow, the process may proceed to step 340, in which strings may be searched for and extracted from virtual memory. If the machine instruction does not affect the control flow, the process may proceed to step 350. In step 340, strings may be searched for and extracted from virtual memory. The search for and extraction of strings may occur each time a machine instruction affects the control flow. This may be done to prevent machine instructions that affect the control flow from overwriting strings in virtual memory.

For example, suppose that during emulation, five machine instructions that affect the control flow may be emulated, but string extraction may be performed only after the last machine instruction is emulated. In that case, only the strings of the last machine instruction may be extracted, because during emulation each machine instruction that affects the control flow may overwrite previous strings. When searching for and extracting strings from virtual memory, all registered virtual memory regions may be processed. If an additional virtual memory region is being processed during emulation of a machine instruction with a number of write attempts greater than or equal to the specified number, emulator 130 may allocate a buffer for it and may perform all the write attempts saved by emulator 130 to write data to this buffer. Before allocating the buffer, the number of written unique ASCII characters may also be taken into account.

The virtual memory regions established during preparation and interpreter initialization may have allocated buffers, and only virtual memory regions with an allocated buffer may be used for searching and extracting strings. Additional virtual memory regions without an allocated buffer may not be processed. To find ASCII strings in a buffer, sequences of ASCII characters of length greater than or equal to a specified number may be searched for. Strings in Unicode encoding may also be searched for. To optimize string search operations, for each virtual memory region the number of virtual addresses at which a write has occurred may be tracked. If there are few virtual addresses, not the entire buffer may be analyzed, but only the areas where writes occurred. This approach may improve emulation performance.

Joint processing of virtual memory regions may occur when they follow one another, since parts of one string may be located in two virtual memory regions. Upon completion of processing all virtual memory regions, the found strings may be extracted by emulator 130 from virtual memory. Access to the emulated virtual memory may be carried out via the virtual memory block, which may check which virtual memory region is being accessed and may perform read/write operations depending on the requested access and configured permissions.

After searching for and extracting strings from virtual memory, the process may proceed to step 350. In step 350, emulator 130 may check whether the limit on the number of machine instructions has been reached (for example, more than 100 machine instructions) or whether an invalid machine instruction has been determined. The limit check may be necessary to optimize the emulation process, preventing emulation beyond a specified instruction count threshold. An invalid instruction may be data similar to code but not a machine instruction. Emulator 130 may not be able to emulate an invalid instruction. An example of an invalid instruction was given earlier in Table 5. If the limit has not been reached and no invalid machine instruction has been determined, the process may proceed to emulate the next machine instruction in step 320. If the limit has been reached or an invalid instruction has been determined, emulation of machine instructions may stop at step 360. In step 370, emulator 130 may perform an additional search for and extraction of strings from virtual memory. The additional search and extraction from virtual memory may be performed if machine instructions that did not affect the control flow were found.

It should be noted that machine instructions that do not affect the control flow may also assemble strings in virtual memory, and there may be a need to perform an additional search for and extraction of such strings from virtual memory. Machine instructions that do not affect the control flow may not overwrite strings in virtual memory and may not require extracting strings immediately after emulating each machine instruction. A list of extracted strings may then be formed and emulator 130 may transfer it to analyzer 140.

In one aspect, in additional step 380, the formed list of extracted strings may be filtered and a final list of extracted strings may be created. Filtering may consist of checking the extracted strings for duplication (repetition) and forming the final list of extracted strings. Strings that are constituent parts of other strings may be removed from the extracted strings, and the final list of extracted strings may be transferred from emulator 130 to analyzer 140. For example, two strings may be extracted: the first extracted string “GetProcAd” at address 0x1337, and the second extracted string “GetProcAddress” at the same address 0x1337. The first extracted string may be a constituent part of the second string; accordingly, the first string may be deleted, and the second may be included in the final list of extracted strings.

Analyzer 140 may be designed to analyze the extracted strings using malicious code detection rules and to detect malicious code based on the analysis performed. Indicators of malicious code may include the presence in the extracted strings of at least function names, library names, and the fact that the code assembles such strings in memory. One malicious code detection rule may be computing a hash of the extracted strings and comparing it with a hash database. Another rule may be comparing the extracted strings with a malware strings database. In one aspect, analyzer 140 may apply a combination of at least two malicious code detection rules when analyzing the extracted strings. Table 6 below shows an example of extracted strings with a machine instruction. In the left column is a sample of a piece of machine instruction in which the string KERNEL32.dll (shown in the right column) may be assembled. Examples of strings may include GetProcAddress, KERNEL32.dll, CreateProcessA, LoadLibraryA, WriteProcessMemory, powershell.exe.

TABLE 6

| Instruction (bytes) | Disassembled instruction |
|---|---|
| C6 44 24 40 4B mov [esp+40h], 4Bh; ‘K’ | KERNEL32.dll |
| C6 44 24 41 45 mov [esp+41h], 45h; ‘E’ | |
| C6 44 24 42 52 mov [esp+42h], 52h; ‘R’ | |
| C6 44 24 43 4E mov [esp+43h], 4Eh; ‘N’ | |
| C6 44 24 44 45 mov [esp+44h], 45h; ‘E’ | |
| C6 44 24 45 4C mov [esp+45h], 4Ch; ‘L’ | |

An example of a malicious code detection rule in a file, applied by analyzer 140, may be the presence in the rule of at least three strings: “CreateProcessA”, “WriteProcessMemory”, “powershell.exe”. A hash may be computed over all extracted strings together. Based on the example above, the strings GetProcAddress, KERNEL32.dll, CreateProcessA, LoadLibraryA, WriteProcessMemory, powershell.exe may produce a hash.

In a particular aspect, after malicious code may be detected by any of the analyses of the extracted strings, the suspicious file may be classified as malicious and the AV software 110 malware database may be updated. In a particular aspect, the malicious file may be sent to the remote service 115 database. In another aspect, if analysis against the malware strings database did not find a match with the extracted strings, and malicious code was detected by analyzer 140 using the rule of computing a hash over the extracted strings and comparing it with a hash database, then the extracted strings may be added to the malware strings database. These databases are not shown in FIG. 1.

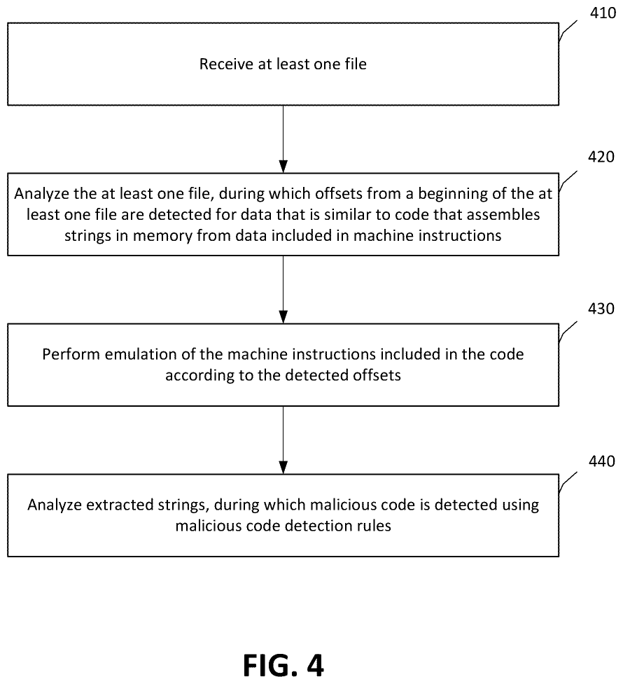

FIG. 4 shows an example method for detecting malicious code in a file. The method 400 for detecting malicious code in a file (hereinafter, method 400) is carried out using system 100. In step 410, AV software 110 receives at least one suspicious file and transfers it to the scanner 120 for analysis. In one aspect, AV software 110 performs an antivirus scan of files. It should be noted that the antivirus scan is performed not only on a single file, but also on a group of files, for example, if it is a computer program. Based on the antivirus scan results, a file is classified as malicious, safe, or suspicious. The antivirus scan includes at least signature analysis using whitelist/blacklist databases and/or heuristic analysis. It should be noted that the present invention is applied to any files, regardless of whether the file is malicious, safe, or suspicious as a result of the antivirus scan.

In one aspect, a suspicious file is transferred for analysis to the scanner 120 from the remote service 115. In another aspect, the content of a memory dump of a computer program subjected to a cyberattack—particularly a targeted attack—is transferred to the scanner 120. AV software 110 detects suspicious actions in the computer program that indicate it has been attacked. Before transferring the content of the program's memory dump to the scanner 120, AV software 110 stops execution of the program.

In step 420, the scanner 120 analyzes each received suspicious file using heuristic analysis, during which each suspicious file is searched for offsets from the beginning of the file to data that is similar to code that assembles strings in memory from data included in machine instructions. The heuristic analysis includes at least signatures aimed at inspecting not all code, but only those places in the code that contain certain sequences of machine instructions. This analysis enables faster code inspection and the selection of more relevant strings compared to the method in which a simple search for machine instructions is performed and then their data are concatenated and checked for ASCII characters. Examples of instruction sequences include:
1) “mov [ . . . ] mov”,
2) “push [ . . . ] pop [ . . . ] mov”,
3) “push [ . . . ] push”, and others.
   The detected offsets are sorted in ascending order by the scanner 120. The sorted offsets are used by emulator 130 as markers (emulation start points) from which code is emulated with subsequent extraction of the assembled strings from virtual memory.

This approach allows the desired strings to be extracted during emulation starting from a set point without needing to collect information about the beginning or end of a function's execution and the possible code emulation paths. In other words, this approach allows emulating not all code, but only the parts necessary for detection, which in turn increases emulation speed. In a particular case, before transferring the detected offsets to emulator 130, the scanner 120 additionally performs verification and filtering of the detected offsets triggered by the specified signatures. When filtering the sorted offsets, the first machine instructions located at the found offsets are analyzed. The analysis takes into account the type of machine instructions, the data they contain, and the size of that data.

The information obtained is processed by heuristic rules aimed at checking the presence of alphanumeric characters relative to null bytes as well as checking for similarity to addresses. Filtering the sorted offsets is necessary to screen out machine instructions related to legitimate software. The heuristic rules used were developed based on a collection of legitimate software. Using filtering of the sorted offsets further increases emulation performance due to the absence of machine instructions related to legitimate software.

In step 430, emulation of machine instructions contained in the code is performed according to the detected offsets, during which at least: (1) the effect of each machine instruction on the control flow is checked, (2) strings are extracted from virtual memory if the machine instruction affects the control flow. At the beginning of the emulation process, emulator 130 prepares virtual memory and initializes the machine instruction interpreter. During emulation, it is checked whether a limit on the number of machine instructions has been reached or whether an invalid machine instruction has been determined. If the instruction limit is reached or an invalid instruction is determined, emulator 130 stops instruction emulation.

In one aspect, emulation of machine instructions continues if the instruction limit has not been reached. In another aspect, an additional search for and extraction of strings from virtual memory is performed if the machine instructions did not affect the control flow. In a particular aspect, additional filtering of the formed list of extracted strings is performed. Strings that are constituent parts of other strings are removed from the extracted strings, and the final list of extracted strings is transferred from emulator 130 to analyzer 140. For example, two strings were extracted: the first “GetProcAd” at address 0x1337, and the second “GetProcAddress” at address 0x1337. The first extracted string is a constituent part of the second string; accordingly, the first string is deleted, and the second is included in the final list of extracted strings.

A detailed description of the emulation process, including the steps listed above, is disclosed in the description of FIGS. 2 and 3. In step 440, analyzer 140 analyzes the extracted strings, during which malicious code is detected using malicious code detection rules. Indicators of malicious code include the presence in the extracted strings of at least function names, library names, and the fact that the code assembles such strings in memory. One malicious code detection rule is computing a hash of the extracted strings and comparing it with a hash database. Another rule is comparing the extracted strings with a malware strings database. In one aspect, analyzer 140 applies a combination of at least two malicious code detection rules.

In a particular aspect, after analyzer 140 detects malicious code based on the analysis of the extracted strings, the suspicious file is classified as malicious and the AV software 110 malware database is updated. In one aspect, the malicious file is sent to the cloud database of remote service 115. In another particular aspect, if analysis against the malware strings database did not find a match with the extracted strings, and malicious code was detected using analyzer 140's rule of computing a hash of the extracted strings and comparing it with a hash database, then the extracted strings are added to the malware strings database. These databases are not shown in FIG. 1.

FIG. 5 is a block diagram illustrating a computer system 20 on which aspects of systems and methods for detecting malicious code in a file may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-4 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for detecting malicious code in a file, comprising:
receiving at least one file;
analyzing the at least one file, during which offsets from a beginning of the at least one file are detected for data that is similar to code that assembles strings in memory from data included in machine instructions;
performing emulation of the machine instructions included in the code according to the detected offsets, further comprising:
checking an effect of each respective machine instruction of the machine instructions on a control flow, and
extracting strings from virtual memory if the respective machine instruction affects the control flow; and
analyzing extracted strings, during which malicious code is detected using malicious code detection rules.

2. The method of claim 1, wherein at a beginning of a machine instruction emulation process, the virtual memory is prepared and a machine instruction interpreter is initialized.

3. The method of claim 1, further comprising, during the emulation of the machine instructions, checking whether a limit on a number of machine instructions has been reached or whether an invalid machine instruction has been detected.

4. The method of claim 3, wherein further emulation of machine instructions is stopped if the limit on the number of machine instructions is reached or if the invalid machine instruction has been detected.

5. The method of claim 1, wherein a search for and extraction of strings from the virtual memory is additionally performed if the machine instructions did not affect the control flow.

6. The method of claim 1, wherein the extracted strings are additionally filtered before analysis.

7. The method of claim 1, wherein an analysis of the at least one file in is performed using signatures, based on which the offsets are detected.

8. The method of claim 1, wherein the detected offsets are additionally filtered to exclude any machine instructions related to legitimate software.

9. The method of claim 1, wherein a combination of at least two malicious code detection rules is applied when analyzing the extracted strings, where at least one rule includes a hash of the extracted strings.

10. A system for detecting malicious code in a file, the system comprising:
at least one memory; and
at least one hardware processor coupled with the at least one memory and configured, individually or in combination, to execute:
a scanner configured to:
receive and analyze at least one file, during which offsets from a beginning of the at least one file are detected for data that is similar to code that assembles strings in memory from data included in machine instructions; and
transfer the at least one file with the detected offsets to an emulator for emulation;
the emulator configured to:
emulate the machine instructions included in the code according to the detected offsets, further comprising checking an effect of each respective machine instruction of the machine instructions on a control flow, and extracting strings from virtual memory if the respective machine instruction affects the control flow; and
an analyzer configured to:
analyze the extracted strings using malicious code detection rules; and
detect malicious code based on an analysis performed.

11. The system of claim 10, wherein at a beginning of a machine instruction emulation process, the emulator prepares the virtual memory and initializes a machine instruction interpreter.

12. The system of claim 10, wherein during the emulation of the machine instructions, the emulator checks whether a limit on a number of machine instructions has been reached or detects an invalid machine instruction.

13. The system of claim 12, wherein the emulator stops the emulation of machine instructions if the limit on the number of machine instructions has been reached or an invalid machine instruction is detected.

14. The system of claim 10, wherein the emulator additionally searches for and extracts strings from the virtual memory even if the machine instructions did not affect the control flow.

15. The system of claim 10, wherein the emulator additionally filters the extracted strings before analysis.

16. The system of claim 10, wherein the scanner analyzes the at least one file using signatures, based on which the offsets are detected.

17. The system of claim 10, wherein the scanner additionally filters the detected offsets to exclude any machine instructions related to legitimate software.

18. The system of claim 10, wherein the analyzer applies a combination of at least two malicious code detection rules when analyzing the extracted strings, where at least one rule includes a string hash.

19. A non-transitory computer readable medium storing thereon computer executable instructions for detecting malicious code in a file, comprising instructions for:
receiving at least one file;
analyzing the at least one file, during which offsets from a beginning of the at least one file are detected for data that is similar to code that assembles strings in memory from data included in machine instructions;
performing emulation of the machine instructions included in the code according to the detected offsets, further comprising:
checking an effect of each respective machine instruction of the machine instructions on a control flow, and
extracting strings from virtual memory if the respective machine instruction affects the control flow; and
analyzing extracted strings, during which malicious code is detected using malicious code detection rules.
